(19) United States
(12) Patent Application Publication
(10) Pub. No.: US 2024/0330598 A1
(43) Pub. Date: Oct. 3, 2024

(54) AI-Enhanced Disaster Safety Knowledge Integration Management System

(71) Applicant: Republic of KOREA (National Disaster Management Research Institute), Ulsan-si (KR)

(72) Inventors: Dong Man LEE, Uiwang-si, Gyeonggi-do (KR); Seon Hwa CHOI, Ulsan-si (KR); Sang Hoon YOON, Ulsan-si (KR); Jong Yeong SON, Ulsan-si (KR); Mi Song KIM, Busan-si (KR); Hee Won YOON, Ulsan-si (KR); Shin Hye RYU, Ulsan-si (KR)

(21) Appl. No.: 18/556,890

(22) PCT Filed: Mar. 9, 2023
(86) PCT No.: PCT/KR2023/003258

§ 371 Date: Oct. 24, 2023

(30) Foreign Application Priority Data
Oct. 6, 2022 (KR) 10-2022-0127828

(51) Int. Cl. G06F 40/35; G06F 40/58

(52) U.S. Cl. CPC G06F 40/35; G06F 40/58

(57) ABSTRACT

Provided is an AI-based disaster safety knowledge integration management system enabling AI-driven question-and-answer services for specialized knowledge in the field of disaster safety and supports automatic reporting services for policy planning and report generation on specific topics by utilizing intelligent analysis services for sharing disaster safety data, and which consists of a disaster safety knowledge base integrated with a data network and an artificial intelligence section designed for high-dimensional information processing;
the disaster safety knowledge base consisting of a data collection section for gathering and aggregating various information from external agencies; and a data transmission section for transmitting the aggregated information to the server; and big data for analyzing and accumulating the transmitted data, and
in the AI section, the accumulated and analyzed data from the big data section being utilized to enable machine intelligence through rapid learning based on human cognitive abilities and learning and inference capabilities.

### TECHNICAL FIELD

The present invention relates to an AI-based Disaster Safety Knowledge Integration Management System, which enables intelligent analysis services for disaster safety data, facilitating query and response services for specialized knowledge in the field of disaster safety by leveraging AI. It also supports the automatic reporting service for policy planning and report generation on specific topics.

### BACKGROUND TECHNOLOGY

The Fourth Industrial Revolution is a transformation of the industrial structure achieved through the intelligence of machinery, resulting in significantly enhanced productivity. It became possible due to the changes in intelligent information technology.

Intelligent information technology combines “intelligence,” which implements high-level information processing similar to human cognition (language, speech, vision, emotion, etc.) through artificial intelligence, with “information” based on data network technologies (ICBM: IoT, Cloud, Big Data, Mobile). Artificial intelligence encompasses technology for implementing human cognitive abilities, such as learning and inference, including artificial intelligence software and hardware as well as foundational technologies. Data network technology serves as a crucial foundation for the rapid improvement, dissemination, and widespread adoption of artificial intelligence technology, involving the essential ICT (Information and Communication Technology) processes of generating, collecting, transmitting, storing, and analyzing data.

Intelligent information technology has advanced to the level of machines capable of autonomous decision-making (performing high-level human judgment functions), real-time responses, autonomous evolution, and enabling the digitization of everything, and it has begun to be applied in various specialized fields.

Recently, the country has been emphasizing the utilization of intelligent information technology on a national level to promote the sharing of data among administrations and public agencies, establish integrated management systems, and activate objective and scientific policy formulation and decision-making. Relevant laws and policies are currently being revised for this purpose.

On the other hand, for efficient responses to new, complex disasters and the establishment of scientific and systematic safety policies, there is a pressing need for data-driven disaster management. To create a legal and institutional framework for systematic data management and facilitate private sector participation in data sharing, there is a need to establish integrated disaster safety data.

Integrated disaster safety data refers to data collected, linked, accumulated, and stored to evolve disaster safety policies based on data, including damage prediction and the identification of vulnerable areas. This encompasses the processes of data collection, linking, accumulation, storage, and making the data accessible and usable to relevant stakeholders.

With the current emphasis on data-centric governance and related policy initiatives, it is imperative to transition from decision-making based on experience and intuition, as in the past, to an objective and scientific administrative system based on data. This shift is crucial for enhancing trustworthiness and improving the quality of life for the citizens. (Refer to FIG. 1)

However, the required data is fragmented and challenging to utilize as information. Furthermore, experiential knowledge is not digitized, and there is also a lack of comprehensive management systems. As a result, the utilization of data-driven disaster safety management is not being fully realized.

Furthermore, in the traditional decision-making process based on experience and intuition, intellectual activities such as policy planning and decision-making are labor-intensive, resulting in significant time and manpower costs. This approach often relies on skilled experts and can lead to blind spots in analysis. Additionally, there is a significant challenge in terms of the substantial time and manpower required for data collection, research, and report writing for policy reporting.

In other words, there are limitations for beginners or those with no experience to conduct analysis directly, and there is a heavy reliance on highly trained professional analysts. This reliance can lead to blind spots in analysis, making it impossible to achieve comprehensive analysis across all relevant areas.

### DETAILED DESCRIPTION OF THE INVENTION

### Technical Challenges

The present invention has a first objective of enabling an AI-based disaster safety domain expert knowledge question-and-answer service and supporting the policy planning and report document creation for specific topics through the utilization of intelligent analysis services for disaster safety data sharing, thus enabling an automatic reporting service.

Another objective of the present invention is to dramatically reduce the time, manpower, costs, and workload involved in data exploration, analysis, and reporting tasks. It aims to enable even non-experts or individuals with relatively little experience to analyze and generate policy documents with the assistance of machines. Additionally, it supports comprehensive decision-making by considering data beyond disasters, new technologies, and emerging issues. This serves as another goal of significantly enhancing the level of disaster safety policy support through integrated knowledge-based insights in the field of disaster safety.

### The Means to Solve the Problem

The present invention relates to an AI-based disaster safety knowledge integrated management system for achieving the above-mentioned objectives. The system utilizes intelligent analysis services for disaster safety data sharing, enabling AI-based disaster safety domain expert knowledge question-and-answer services and supporting policy planning and report document creation for specific topics through an automatic reporting service. The system is comprised of a disaster safety knowledge base unit integrated with data networks and an artificial intelligence unit for implementing high-level human information processing capabilities.

The disaster safety knowledge base unit includes a data collection unit for gathering various information from external organizations, a data transmission unit for transmitting the collected information to servers through LTE, 5G, WIFI, etc., and a big data unit for analyzing and accumulating the transmitted data.

The data collection unit provides general information such as disaster situations, statistics, policies, reports, as well as unstructured data from news, SNS, laws, reports, and structured data such as damage recovery, weather, safety indices, disaster incidents, 119 reports, etc. The big data unit distinguishes and analyzes the provided data, categorizing it into disaster damage status, disaster response history, and disaster safety policy information, thus archiving the data for open sharing with target users (general citizens, relevant agencies, etc.). The artificial intelligence unit utilizes the data accumulated and analyzed in the big data unit to enable rapid machine learning through human-like cognitive abilities (language, speech, vision, emotions), learning, and inference functions.

In the artificial intelligence unit, from objective facts in data, information is derived through semantic extraction and pattern recognition, leading to the understanding of relationships and correlations through associations/correlations. Information is internalized into unique knowledge, resulting in structured knowledge, and ultimately, structuring knowledge leads to the extraction of wisdom as a creative output.

The data collection unit of the disaster safety knowledge base gathers overseas data, unstructured data, and structured data, which are then accumulated in the big data unit through knowledge resource collection/management, human-like knowledge learning, and natural language understanding knowledge learning. In the big data unit, in addition to natural language understanding knowledge learning, knowledge curation and complex inference knowledge augmentation can also be provided.

The artificial intelligence unit uses the data accumulated and analyzed in the big data unit to execute judgments and inferences based on human cognitive abilities (language, speech, vision, emotions) and learning and inference functions. It involves processes such as interpreting queries from external sources, keyword analysis, problem analysis based on situational analysis, selecting/producing answers through self-learning and judgment/pre-learning, and generating analysis reports automatically.

The disaster safety knowledge base consists of a complex inference knowledge augmentation unit, a natural language understanding knowledge learning unit, a human-like knowledge learning unit, and a perception resource collection/management unit.

The complex inference knowledge augmentation unit extracts rules and knowledge relationships from structured and unstructured documents and explores/infer new facts based on them.

The natural language understanding knowledge learning unit analyzes the structure, context, and intent of the query received from the user, enhancing natural language understanding.

The human-like knowledge learning unit mimics human cognitive and judgment functions, improving performance through self-learning based on data accumulated in the knowledge base. The knowledge resource collection/management unit collects and manages various data, including unstructured/structured data and overseas data.

The artificial intelligence unit functions as a disaster safety knowledge bot capable of deep query responses through AI, including user interface, query/keyword input, problem analysis, user intent understanding, answer candidate search/inference, answer selection/production, and answer generation.

The query/keyword input section collects queries/keywords from users and consists of a query collection section for identifying contextual errors and typos in queries and a query identification section for forwarding queries/keywords to the problem analysis section.

The problem analysis section includes a query interpretation section for interpreting the sentence structure and words in the input query and a situational interpretation section for interpreting the context and situation in the query.

The user intent understanding section extracts the user's intent contained in the query and consists of an intent extraction section for conveying the intent extracted from the data received by the intent extraction section.

The answer candidate search/inference section includes a candidate search section for searching for answer candidates based on the analyzed query and an answer candidate inference section for ranking and inferring the optimal answer candidates based on the user's intent and context.

The answer selection/generation section consists of an answer selection section for choosing the most optimal response based on the ranked answer candidates and an answer generation section for creating responses based on the selected answer. The response generation section is composed of a response implementation section for generating responses in user-friendly conversational style and a response presentation section for delivering responses to the user interface.

### The Effectiveness of the Invention

In the AI-based disaster safety knowledge integrated management system according to the present invention, there is an effect of enabling AI-based disaster safety domain expert knowledge question-and-answer services and supporting the policy planning and report document creation for specific topics through an automatic reporting service by utilizing intelligent analysis services for disaster safety data sharing.

Furthermore, there is an effect of dramatically reducing the time, manpower, costs, and workload involved in data exploration, analysis, and reporting tasks. It enables even non-experts or individuals with relatively little experience to analyze and generate policy documents with the assistance of machines. Additionally, it supports comprehensive decision-making by considering data beyond disasters, new technologies, and emerging issues. This serves as another effect of significantly enhancing the level of disaster safety policy support through integrated knowledge-based insights in the field of disaster safety.

### BRIEF EXPLANATION OF DRAWINGS

FIG. 1 is a block diagram illustrating an overview of the configuration of the present invention.

FIG. 2 is a diagram depicting an overview of disaster safety knowledge consulting technology according to the present invention.

FIG. 3 is a diagram illustrating the configuration of an AI-based disaster safety knowledge integrated management system according to the present invention, and FIG. 4 is a diagram illustrating a process in which disaster safety management is traditionally carried out based on user experience and intuition.

### SPECIFIC DETAILS FOR IMPLEMENTING THE INVENTION

Below, a preferred embodiment of the present invention will be described in more detail with reference to the attached drawings. However, it should be understood that the scope of the present invention is not limited to this.

In this specification, the embodiments are provided to fully disclose the scope of the invention to those skilled in the art to which the invention pertains, to ensure that the initiation of the invention is complete, and the scope of the invention is defined only by the claims. Therefore, in some embodiments, well-known components, well-known operations, and well-known technologies are not specifically described to avoid any ambiguity in the interpretation of the invention.

The terms used in this specification are for the purpose of describing embodiments and are by no means intended to limit the invention. In this specification, the singular also includes the plural unless specifically mentioned otherwise. Additionally, the components and operations mentioned as “including (or, equipped with)” do not exclude the presence or addition of one or more other components and operations.

The present invention pertains to an AI-based disaster safety knowledge integrated management system that, by utilizing intelligent analysis services for sharing disaster safety data, enables AI-driven query and response services for expert knowledge in the field of disaster safety, as well as supports policy planning and the creation of report documents for specific topics through an automatic reporting service.

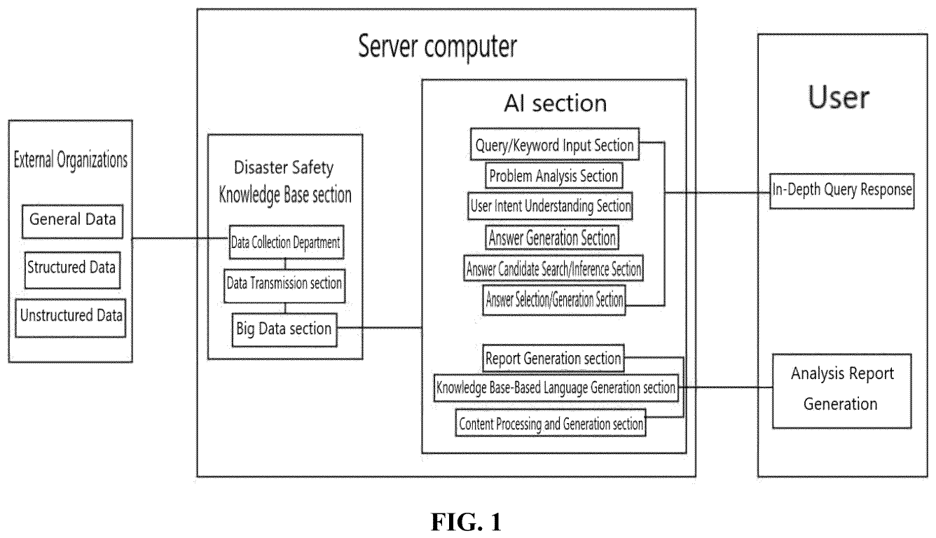

This invention can be broadly categorized into a disaster safety knowledge base unit integrated with data networks and an artificial intelligence unit designed to implement high-level human information processing capabilities, as illustrated in (FIG. 1).

The aforementioned disaster safety knowledge base unit consists of a data collection unit for gathering various information from external organizations, a data transmission unit for sending the aggregated information to servers via LTE, 5G, WIFI, etc., and a big data unit for analyzing and accumulating the transmitted data.

In the data collection unit, various types of data are provided, including general information such as disaster situations, statistics, disaster policies, situation reports, and research reports, as well as unstructured data from sources like news, social media, laws, situation reports, research reports, and structured data like damage recovery, weather, safety indices, disaster incidents, and 119 reports. Depending on the scenario, data collection through loT, which enables information exchange among all objects, such as machine-to-machine and machine-to-human, is also possible. The big data unit enhances data accumulation and analysis capabilities through advanced information processing.

In the aforementioned artificial intelligence unit, the accumulated and analyzed data from the big data unit is leveraged to enable machine intelligence through rapid learning based on human cognitive abilities (language, speech, vision, emotions), learning, and inference functions. This empowers the machine to become intelligent and create new value.

Moreover, the data collection unit can collaborate with other systems or organizations to provide data. For example, it can integrate with the National Safety Information Integrated Disclosure System to provide safety inspection information, connect with the National Disaster Management Information System to offer disaster management information, interface with the Safety Information Integrated Management System to provide safety statistics, coordinate with the Safety Reporting System to supply safety incident reports,

collaborate with disaster response agencies to furnish disaster case studies, partner with white paper-producing organizations to deliver disaster incident white papers, and cooperate with disaster safety research institutions to provide research reports.

In the aforementioned big data unit, the provided data from the data transmission unit is categorized, analyzed, and accumulated. It distinguishes and analyzes real-time data such as landslide sensors, quantity and water level information, disaster scene photos, along with structured data like past damage history information and various facility safety data. Additionally, it separates and analyzes unstructured data such as disaster situation text, disaster situation image, briefing materials, and more.

The data, once categorized and analyzed in this manner, is archived and accumulated as disaster damage status, disaster response history, and disaster safety policy information. This enables the data to be open and shared with the intended recipients, such as the general public and relevant agencies.

Meanwhile, for fragmented data to be effectively utilized as valuable information, it requires a comprehensive exploration and knowledge synthesis. This process involves extracting meaning and patterns from raw data, understanding relationships and correlations through objective facts (Data), turning them into information (Information), internalizing them as proprietary knowledge (Knowledge), and ultimately structuring knowledge to produce creative output in the form of wisdom (Wisdom).

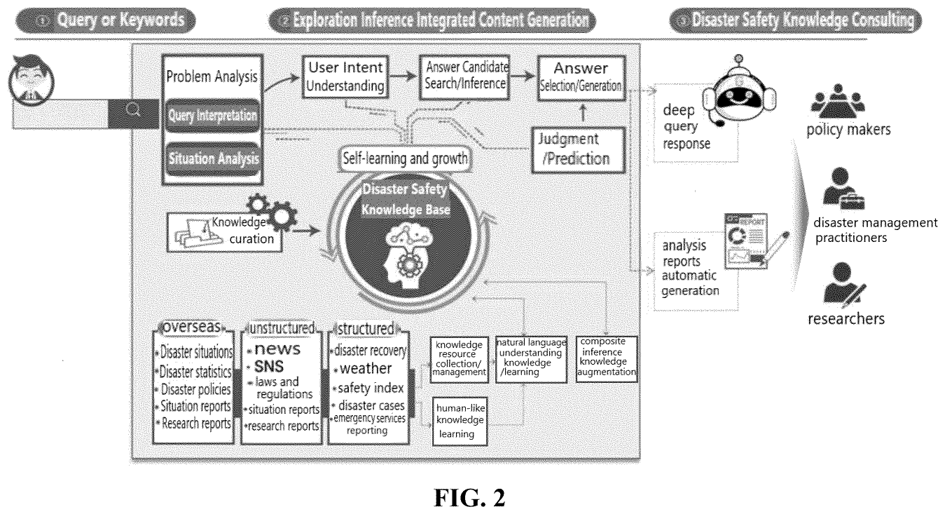

FIG. 2 illustrates an overview of disaster safety knowledge consulting technology according to the present invention. In the data collection unit of the disaster safety knowledge base, various overseas data such as disaster situations, disaster statistics, and disaster policies, along with unstructured data such as news, SNS, and laws, as well as structured data including recovery information, weather data, safety indices, etc., are collected. These knowledge resources are accumulated in the big data unit of the disaster safety knowledge base through processes like knowledge acquisition/management or human-like knowledge learning and natural language understanding knowledge learning. The big data unit offers not only natural language understanding knowledge learning but also knowledge curation and complex inference knowledge enhancement.

In the artificial intelligence unit, the data accumulated and analyzed in the big data unit is utilized to execute processes involving human cognitive abilities (language, speech, vision, emotion, etc.), learning, and inference functions.

This includes understanding user intentions through processes such as query interpretation based on external queries and keywords, situation analysis, problem analysis; searching and inferring potential answers; self-learning and growth, judgment, and anticipation; and finally, providing in-depth query responses or automatically generating analysis reports.

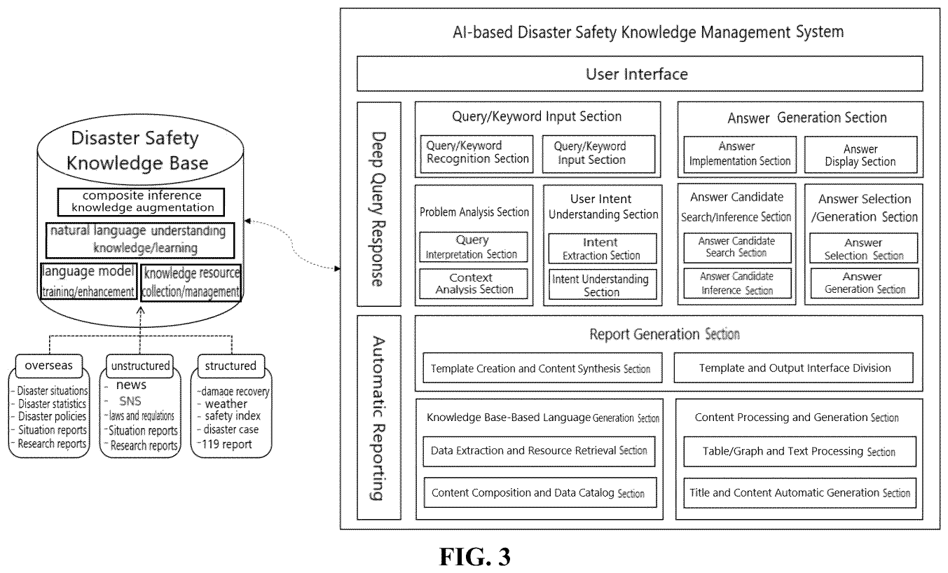

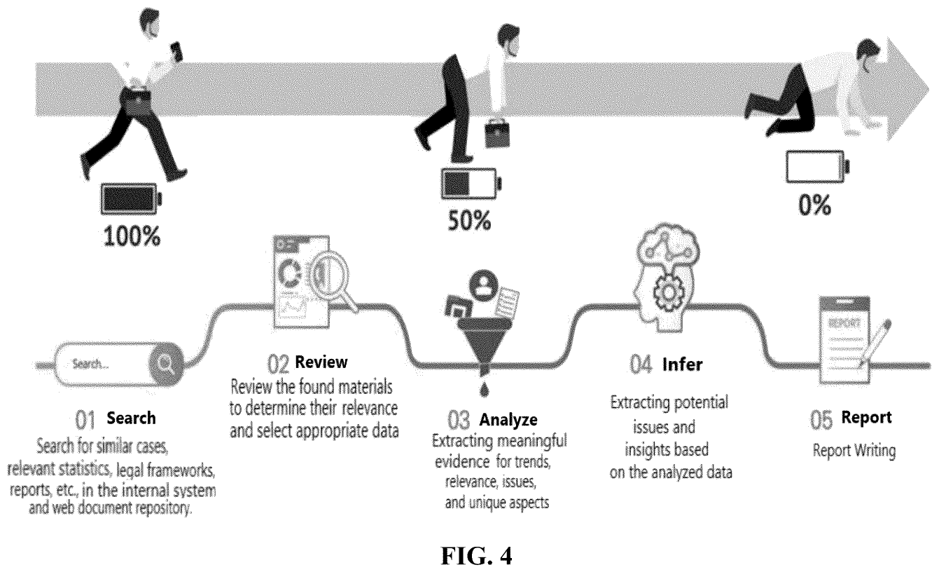

FIG. 3 represents the configuration of the disaster safety knowledge integrated management system powered by AI according to the present invention. This system utilizes language, learning, and inference intelligence (AI) technologies to not only provide factual information such as disaster safety cases, experiences, and statistics but also support in-depth query responses through query inference. It pertains to a disaster safety knowledge bot capable of using AI technology.

The disaster safety knowledge base is a disaster safety knowledge dataset that utilizes big data and AI technologies for data-driven decision support, facilitating efficient information sharing in disaster situations. It consists of the Base Complex Inference Knowledge Augmentation Unit, Natural Language Understanding Knowledge Learning Unit, Human-Like Knowledge Learning Unit, and Knowledge Resource Collection/Management Unit.

The Base Complex Inference Knowledge Augmentation Unit extracts rules and knowledge relationships from structured and unstructured documents, explores and infers new facts based on them, and generates knowledge.

The Natural Language Understanding Knowledge Learning Unit enhances natural language understanding by analyzing the structure, context, and intent of user queries and accumulating the results.

The Human-Like Knowledge Learning Unit mimics human cognitive and judgment functions, enhancing its performance through self-learning based on data accumulated in the knowledge base.

The Knowledge Resource Collection/Management Unit is designed to collect and manage unstructured and structured data, including various international data sources.

On the other hand, the artificial intelligence unit can be considered as a disaster safety knowledge bot capable of deep query responses using AI. It consists of user interface, query/keyword input section, problem analysis section, user intent understanding section, answer candidate search/inference section, answer selection/generation section, and answer generation section.

The query/keyword input section comprises a query/keyword collection unit for gathering queries/keywords from users and a query identification unit for identifying contextual errors or typos in queries/keywords, requesting re-entry, or passing them to the problem analysis section.

The problem analysis section includes a query interpretation unit for interpreting the sentence structure and words in the entered query and a context interpretation unit for interpreting the situation and context included in the query.

The user intent understanding section consists of an intent extraction unit for extracting the user's intent included in the query and an intent interpretation unit to interpret the user's intent contained in the data received from the intent extraction unit.

The answer candidate search/inference section is composed of an answer candidate search unit for exploring answer candidates based on the analyzed query and an answer candidate inference unit for ranking answer candidates based on the user's intent and context from the answer candidate list.

For example, the word ‘apple’ can have two meanings depending on the query's intent, forgiveness, and fruit. Homonyms like this require different answers based on the user's intent and context.

The answer selection/generation section consists of an answer selection unit that selects the most optimal response based on ranked answer candidates and an answer generation unit that generates answers based on the selected answer.

The answer generation section is further divided into an answer formulation unit, which generates responses in an easily understandable conversational style, and an answer presentation unit, which delivers the response to the user interface.

Furthermore, the artificial intelligence unit can provide services to support decision-making and reduce time and resource consumption by automatically assisting in policy planning and report generation. It can include a report generation unit, a knowledge base-based language generation unit, and a content processing and generation unit.

The report generation unit is composed of a template generation and content synthesis unit, which generates report content in accordance with template formats, and a template and output interface unit, which provides the generated report content in a user-friendly template format for easy understanding.

The knowledge base-based language generation unit includes a data extraction and support search unit, which extracts and searches for the necessary data from the disaster safety knowledge base, and a content composition and data catalog unit, which composes content based on the extracted and searched data.

The content processing and generation unit comprises a table/graph and text processing unit, which generates statistics data (tables/graphs) based on text, and a title and content automatic generation unit, which generates content in an easily understandable format and extracts and summarizes key content.

Therefore, in the artificial intelligence unit, the data accumulated and analyzed in the big data unit is utilized to enable step-by-step execution of judgment and inference based on human cognitive abilities (language, speech, vision, emotion) and learning and inference functions.

Additionally, in the query/keyword input section of the artificial intelligence unit, deep query responses are performed through query-response/keyword search driven by the chatbot operating device. It consists of chatbot operating devices, input devices, management systems, machine learning tools, and modules for query-response dictionary management, user intent recognition, conversation agents, and conversation management systems.

In the query-response dictionary management module, session control is used to manage Intent Finder and Dialog Agent delivery content. Sessions are created based on four conditions: USER, DEVICE, CHATBOT, and a specific time range.

In the user intent recognition module, user intent is identified, and messages are delivered to the most suitable DIALOG AGENT. It is designed to identify conversation intent based on various features and support answer exploration.

In the conversation agent system, it responds to user utterances in a Dialog Agent platform environment, developed and deployed in the disaster safety data environment, and registered and executed through ADMI.

The conversation management system allows for various types of conversations, including everyday conversations, news, and more, based on Q&A engines and knowledge base types. It also enables slot and task definitions in SDS scenarios generated by conversation modeling tools.

In this invention, there is a functionality for generating reports either semi-automatically or automatically. The report design and report server parts generate reports through data links and are configured to provide a process for report integration/distribution and report utilization.

Various reports created based on report agents connected to different report writing sources (such as knowledge bases) are integrated at the distribution server level and then transferred to the reporting server to be exposed to users through the application server's content management system.

As described above, the AI-based disaster safety knowledge integration management system according to the present invention allows for the intelligent analysis of disaster safety data through the sharing of disaster safety data. This enables AI-based query and response services for specialized knowledge in the field of disaster safety and supports the automatic reporting service for policy planning and report generation on specific topics. Furthermore, it drastically reduces the time, manpower, costs, and workload involved in data exploration, analysis, and reporting tasks. It enables non-experts or individuals with relatively less experience to perform analysis and policy document generation with the assistance of machines. It also supports comprehensive decision-making by considering data beyond disasters, new technologies, and emerging issues, thus significantly enhancing the level of support for disaster safety policy.

The technical idea of the present invention has been described in a desirable embodiment, but it should be noted that the mentioned embodiments are for the purpose of description and not for limitation. Various modifications and alterations are possible within the scope of the technical concept of the present invention, and it is understood that such modifications and alterations are included within the attached patent claims.

1. An AI-Enhanced Disaster Safety Knowledge Integration Management System, which enables AI-driven question-and-answer services for specialized knowledge in the field of disaster safety and supports automatic reporting services for policy planning and report generation on specific topics by utilizing intelligent analysis services for sharing disaster safety data, and which consists of a disaster safety knowledge base integrated with a data network and an artificial intelligence section designed for high-dimensional information processing;
the said disaster safety knowledge base consisting of a data collection section for gathering and aggregating various information from external agencies; and a data transmission section for transmitting the aggregated information to the server via LTE, 5G, WIFI, and similar means; and a big data for analyzing and accumulating the transmitted data, and
in the said big data section, the data provided by the data transmission section being categorized, analyzed, and accumulated, and being categorized and analyzed as real-time data including rapid slope sensors, quantity and water level information, and disaster incident scene photos; structured data like historical damage records and various facility safety information; and unstructured data such as disaster situation reports in text, disaster situation images, briefing materials, and the data categorized and analyzed in this way being archived under disaster incident damage status, disaster incident response history, and disaster safety policy information, and in the said AI section, the accumulated and analyzed data from the big data section being utilized to enable machine intelligence through rapid learning based on human cognitive abilities (language, speech, vision, emotion, etc.) and learning and inference capabilities, and
the AI section functions as a deep-query responding disaster safety knowledge bot, comprising user interface, query/keyword input section, problem analysis section, user intent understanding section, solution candidate search/inference section, solution selection/generation section, and response generation section, and
the query/keyword input section of the said AI system performing in-depth query responses and keyword searches driven by chatbot devices, and the query/keyword input section of the AI system being composed of modules including chatbot device and input device, management system, machine learning tools, query-response pre-management module, user intent recognition module, conversation agent, and conversation management system, and
in the said query-response pre-management module, session control being used to manage the delivery of Intent Finder and Dialog Agent content, Sessions being created using four conditions: USER, DEVICE, CHATBOT, and a certain time range,
and the said user intent recognition module being configured to identify the user's intent to deliver messages to the most suitable DIALOG AGENT and support answer exploration based on various features that determine conversation intent, and
the conversation agent system being configured to respond to user utterances in the conversation agent (Dialog Agent) platform environment, developed and deployed in the disaster safety data environment, and registered and executed through ADMI, and
the conversation management system being configured to enable various types of conversations, including everyday conversations and news, based on Q&A engines and knowledge base types, and to enable slot and task definition in SDS scenarios generated as conversation modeling tools.

2. The AI-Enhanced Disaster Safety Knowledge Integration Management System of claim 1, wherein associations/correlations are understood through meaning extraction and pattern recognition from objective facts in the form of data (Data), leading to information (Information) transformation. The resulting information, internalized as proprietary knowledge, is structured into knowledge (Knowledge), ultimately resulting in knowledge structuring in the said artificial intelligence section.

3. The AI-Enhanced Disaster Safety Knowledge Integration Management System of claim 1, wherein the collected overseas data, unstructured data, and structured data are accumulated in the big data section of the disaster safety knowledge base after undergoing knowledge resource collection/management or human-like knowledge learning and natural language understanding knowledge learning in the data collection section of the disaster safety knowledge base, and in addition to natural language understanding knowledge learning, knowledge curation and composite inference knowledge augmentation are also provided in the big data section.

4. The AI-Enhanced Disaster Safety Knowledge Integration Management System of claim 1, wherein the data accumulated and analyzed in the aforementioned big data section are utilized to enable machine intelligence through rapid learning based on human cognitive abilities (language, speech, vision, emotion, etc.) and learning and inference capabilities in the said artificial intelligence section, and this process involves the interpretation of queries and problem analysis based on situational analysis, leading to the understanding of user intent; the search and inference of answer candidates; self-learning and growth, judgment, and anticipation, leading to the selection/production of answers; and ultimately, the deep query response or automatic report generation process.

5. The AI-Enhanced Disaster Safety Knowledge Integration Management System of claim 1, wherein the disaster safety knowledge base, as disaster safety knowledge data that supports efficient information sharing in disaster situations using big data and AI technologies for data-driven decision support, is composed of a complex inference knowledge augmentation section, a natural language understanding knowledge learning section, an artificial intelligence knowledge learning section, and a perception resource collection/management section.

6. The AI-Enhanced Disaster Safety Knowledge Integration Management System of claim 5, wherein the said complex inference knowledge augmentation section is configured to extract rules and knowledge relationships from structured and unstructured documents, and based on this, new facts are explored and inferred to generate knowledge.

7. The AI-Enhanced Disaster Safety Knowledge Integration Management System of claim 5, wherein the natural language understanding knowledge learning section is configured to analyze the structure, context, and intent of queries received from users, and the results of this analysis are accumulated to enhance natural language understanding.

8. The AI-Enhanced Disaster Safety Knowledge Integration Management System of claim 1, wherein the query/keyword input section is composed of a query/keyword collection section for collecting queries/keywords from users and a query identification section for identifying contextual errors or typos in the queries/keywords themselves, requesting re-entry, or forwarding them to the problem analysis section.

9. The AI-Enhanced Disaster Safety Knowledge Integration Management System of claim 1, wherein the problem analysis section is composed of a query interpretation section for interpreting the sentence structure and words of the entered query and a situational interpretation section for interpreting the context and situation contained in the query.

10. The AI-Enhanced Disaster Safety Knowledge Integration Management System of claim 1, wherein the user intent understanding section consists of an intent extraction section that extracts the user's intent contained in the query and forwards it to the intent interpretation section, and an intent interpretation section that interprets the user's intent contained in the data received from the intent extraction section.

11. The AI-Enhanced Disaster Safety Knowledge Integration Management System of claim 1, wherein the answer candidate search and inference section consists of an answer candidate search section that searches for answer candidates based on the analyzed query and an answer candidate inference section that ranks and infers the optimal answers from the answer candidate list based on the user's intent and context.

12. The AI-Enhanced Disaster Safety Knowledge Integration Management System of claim 1, wherein the answer selection/generation section consists of an answer selection section that chooses the best answer based on the ranked answer candidates and an answer generation section that generates responses based on the selected answer.

13. The AI-Enhanced Disaster Safety Knowledge Integration Management System of claim 1, wherein the response generation section consists of a response implementation section that generates responses in user-friendly colloquial sentences and a response presentation section for delivering responses to the user interface.

14. The AI-Enhanced Disaster Safety Knowledge Integration Management System of claim 1, wherein the artificial intelligence division is further equipped with a report generation section, a knowledge-based language generation section, and a content processing and generation section to provide services aimed at assisting decision-making, reducing time and labor costs through automated policy planning and report generation.

15. The AI-Enhanced Disaster Safety Knowledge Integration Management System of claim 14, wherein the report generation section is composed of a template creation and content synthesis section, which ensures that the report content is generated in accordance with the template format, and a template and output interface section that provides the generated report content in a user-friendly manner aligned with the template format.

16. The AI-Enhanced Disaster Safety Knowledge Integration Management System of claim 14, wherein the knowledge base-based language generation section consists of a data extraction and support search section for extracting and searching the necessary data from the disaster safety knowledge base, and a content composition and data catalog section for structuring content based on the extracted and searched data.

17. The AI-Enhanced Disaster Safety Knowledge Integration Management System of claim 14, wherein the content processing and generation section consists of a table/graph and text processing section for generating statistical data (tables/graphs) based on text and a title and content automatic generation section for creating content in a user-friendly format and extracting/summarizing key information.

18. The AI-Enhanced Disaster Safety Knowledge Integration Management System of claim 4, wherein the report design and report server part are configured to generate reports through data links and provide a process for report integration/distribution and report utilization, and various reports created based on report sources (knowledge bases, etc.) integrated with report agents are distributed on the distribution server and the report contents reflected in the content management system of the application server are finally transferred to the reporting server and exposed to users.
